(19) United States
(12) Patent Application Publication
(10) Pub. No.: US 2007/0042632 A1
(43) Pub. Date: Feb. 22, 2007

(54) Pin clamp assembly

(76) Inventors: Parag Patwardhan, Fort Wayne, IN (US); Bruce D. McIntosh, Monroeville, IN (US)

Correspondence Address: Barnes & Thornburg LLP, 600 One Summit Square, Fort Wayne, IN, 46802, US

(21) Appl. No.: 11/505,533

(22) Filed: Aug. 17, 2006

Related U.S. Application Data
(60) Provisional application No. 60/709,661, filed on Aug. 19, 2005.

(51) Int. Cl. H01R 13/62

(52) U.S. Cl. 439/372

(57) ABSTRACT

A pin clamp assembly having a driver, a body, an actuator, a locating pin and at least one finger is provided. The body receives at least a portion of the driver. The actuator assembly moves the driver linearly. The locating pin has a longitudinal extent or axis and receives at least a portion of the finger. At least a portion of the finger is locatable in the locating pin and at least a portion is selectively extendable therefrom. The finger is linearly movable between extended and retracted positions.

### RELATED APPLICATIONS

The present application is related to and claims priority to U.S. Provisional Patent Application, Ser. No. 60/709,661, filed on Aug. 19, 2005, entitled Pin Clamp Assembly. The subject matter disclosed in that provisional application is hereby expressly incorporated into the present application.

### TECHNICAL FIELD

The present disclosure is related to pin clamp assemblies, and in particular, to pin clamp assemblies that translate movement from a driver to a finger which is extendable to selectively engage and hold a workpiece.

### BACKGROUND AND SUMMARY

Pin clamp assemblies are generally known in the art. Typically pin clamps include a clamp body with a locating pin that is extendable therefrom. The locating pin is extendable through a hole or edge located on a panel such as a piece of sheet metal or other comparable workpiece. Once the locating pin is through the hole, a clamping member pivots to engage the workpiece, holding the same in place against the clamp body. Once held in place, the workpiece can be subjected to any desired operation and then released. The pin clamp of the present disclosure is an alternative to the prior art pin clamps.

An illustrative embodiment of the present disclosure provides a pin clamp assembly that comprises a driver, a body, and actuator, a locating pin and at least one finger. The body has a cavity that receives at least a portion of the driver and which comprises first and second stops. The actuator assembly comprises a drive rod that moves the driver linearly. The locating pin has a longitudinal extent and receives at least a portion of the driver. At least a portion of the finger is locatable in the locating pin, and at least a portion is selectively extendable therefrom. The driver is linearly movable between the stops to move the finger between extended and retracted positions. At least a portion of the actuator assembly and the driver move substantially parallel to each other to move the finger. The portion of the actuator assembly and the driver move non-parallel to the longitudinal extent of the locating pin.

In the above and other illustrative embodiments, the pin clamp assembly may also comprise: a driver having first and second stop surfaces located thereon; at least a portion of the actuator assembly and the driver moving along a linear path transversely located relative to the longitudinal extent of the locating pin; at least a portion of the actuator assembly and the driver moving linearly at an approximate 45 degree angle to the longitudinal extent of the locating pin; a finger moving substantially parallel to at least a portion of the actuator assembly; a first stop surface located adjacent a first stop when the finger is located in the retracted position and a second stop surface located adjacent a second stop when the finger is located in the extended position; a finger moving linearly and substantially parallel to movement of the driver and at least a portion of the actuator assembly; an actuator assembly comprising a piston that moves substantially parallel to the driver; a piston, actuator assembly and finger all moving substantially parallel to each other to extend and retract the finger to and from the locating pin; a locking assembly that holds the driver preventing it from moving until forced to do so by the actuator assembly; a locking assembly comprising a wedge that engages the driver holding it in place until that actuator assembly dislodges the wedge allowing the driver to resume movement; a sensor that detects the location of the driver; a sensor that detects when a workpiece engages the pin clamp assembly; and a sensor assembly that detects the location of the driver and when a workpiece engages the pin clamp assembly.

Another illustrative embodiment of the present disclosure provides a method of holding a panel having a grippable edging or a hole disposed therethrough. This method comprises the steps of: providing a locating pin that defines a longitudinal axis, a surface, and a piston coupled to a driver which is coupled to a finger located in the locating pin; locating the locating pin through the hole or adjacent the edging; moving the piston linearly and transversely to the longitudinal axis of the locating pin; moving a driver via movement of the piston linearly and substantially parallel to the piston; moving the finger linearly via movement of the driver at least partially outwardly from the locating pin and holding the panel against the surface with the finger.

The method of holding the panel may further comprise the steps of: moving the finger substantially parallel to the piston; providing opposed stops with a portion of the driver located therebetween; limiting movement of the finger based on the distance between the stops; and holding the finger at a location under a loss of power on the piston.

Another illustrative embodiment of the pin clamp assembly comprises a locating pin having a longitudinal axis extending therethrough, a piston, a driver and a finger. The piston is linearly movable transversely to the longitudinal axis of the locating pin. The driver is spaced apart from the piston and is movable substantially parallel to the movement of the piston. The finger is movable substantially parallel to the movement of the driver, and at least a portion of the finger is movable into and out of the locating pin.

In the above and other illustrative embodiments, the pin clamp assembly may also comprise the piston, driver and finger moving linearly at an approximate 45 degree angle to the longitudinal axis. It is appreciated that the angle may alternatively be about 20 degrees or about 60 degrees, for example. Other angles may work as well.

Additional features and advantages of the pin clamp assembly will become apparent to those skilled in the art upon consideration of the following detailed description of the illustrated embodiments exemplifying the best mode of carrying out the pin clamp assembly as presently perceived.

### BRIEF DESCRIPTION OF DRAWINGS

The present disclosure will be described hereafter with reference to the attached drawings which are given as non-limiting examples only, in which:

FIG. 1 is a perspective view of an illustrative embodiment of a pin clamp assembly;

FIGS. 2a-c are several perspective views of a pin clamp assembly demonstrating a utility of same;

FIG. 3 is an exploded view of an illustrative embodiment of a pin clamp assembly;

FIGS. 4a and b show an end view and corresponding cross-sectional view of an illustrative embodiment of a pin clamp assembly;

FIGS. 5a-c are side cross-sectional views of an illustrative embodiment of a pin clamp assembly showing progressional movement of structures within the pin clamp assembly;

FIGS. 6a-e are partial cut-away views of an illustrative embodiment of a pin clamp assembly showing an illustrative embodiment of a locking mechanism;

FIG. 7 shows a side interior and partial phantom view of the illustrative locking mechanism in a pin clamp assembly;

FIGS. 8a and b are detail views of the pin clamp assembly of FIG. 7, showing an unlocking component to the locking mechanism;

FIGS. 9a-c are perspective views of an illustrative embodiment of a pin clamp demonstrating an illustrative embodiment of a switch assembly;

FIGS. 10a and b are side views of the illustrative pin clamp assembly also showing the illustrative switch assemblies; and

FIG. 11 is a perspective view of an illustrative embodiment of a finger.

Corresponding reference characters indicate corresponding parts throughout the several views. The exemplification set out herein illustrates embodiments of the pin clamp assembly, and such exemplification is not to be construed as limiting the scope of the pin clamp assembly in any manner.

### DETAILED DESCRIPTION OF THE DRAWINGS

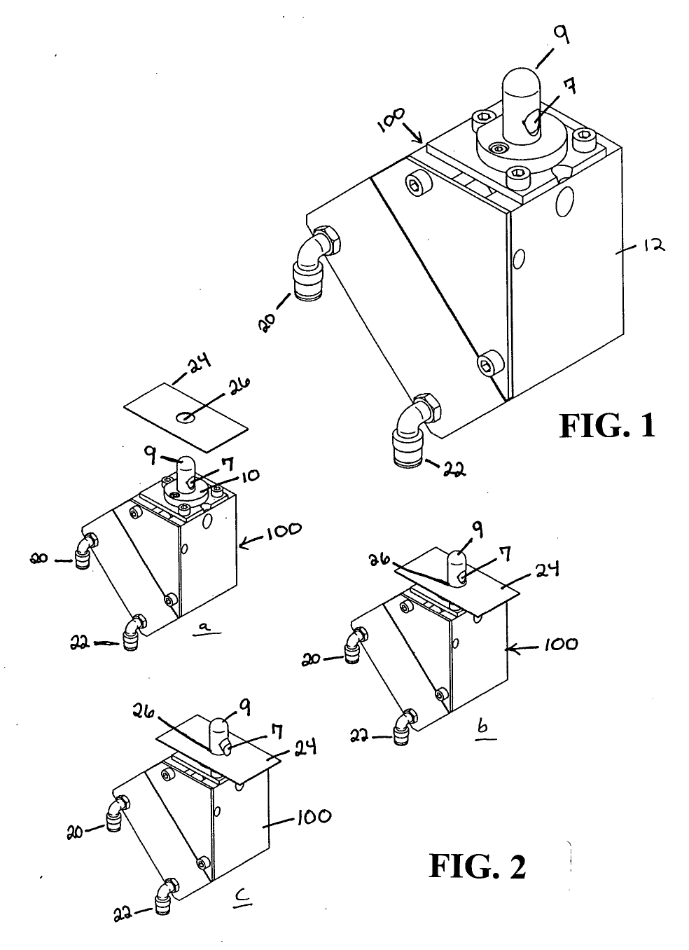

A perspective view of pin clamp assembly 100 according to an illustrative embodiment is shown in FIG. 1. Illustratively, clamp assembly 100 is configured to receive fluid power through ports 20 and 22 that will extend or retract finger 7 from main pin 9. It is appreciated, however, that other means of power can be employed to extend or retract finger 7. For example, in an alternative embodiment clamp assembly 100 may be configured to use electrical power to extend and retract finger 7 by replacing piston assembly 42 to move drive pin 5. (See also, FIG. 5b.)

A utility of pin clamp assembly 100 is demonstrated in the perspective views of FIGS. 2a-c. Illustratively, as shown in FIG. 2a, a workpiece 24 having a hole or opening 26 disposed therethrough is positionable over clamp assembly 100. It is appreciated that workpiece 24 may be a panel of sheet metal or other rigid or semi-rigid material. The workpiece may also be of any variety of appropriate thicknesses. Opening 26 may be of the type shown in FIG. 2a or could be a notch or hole of varying shapes yet still configured to receive pin 9. As shown in FIG. 2b, workpiece 24 is positioned on clamp assembly 100 with pin 9 disposed through opening 26. In this example workpiece 24 rests on support boss 10. Once pin 9 is disposed through opening 26, finger 7, shown in the retracted position, is available to extend to engage and hold workpiece 24. In this embodiment, fluid can be supplied through port 20 to extend finger 7. The fluid moves piston 11 inside the assembly. (See also FIGS. 5a-c.) Illustratively, fluid on the other side of the piston can escape through port 22. As shown in FIG. 2c, finger 7 is extended outwardly and downwardly to hold workpiece 24 onto support boss 10. (See, also, FIG. 2a.) It is appreciated that fluid can be supplied to port 22 to retract finger 7 as well. In this case, fluid can escape through port 20. Also in other embodiments, the ports can be reorganized as desired to create the appropriate movement of the driver.

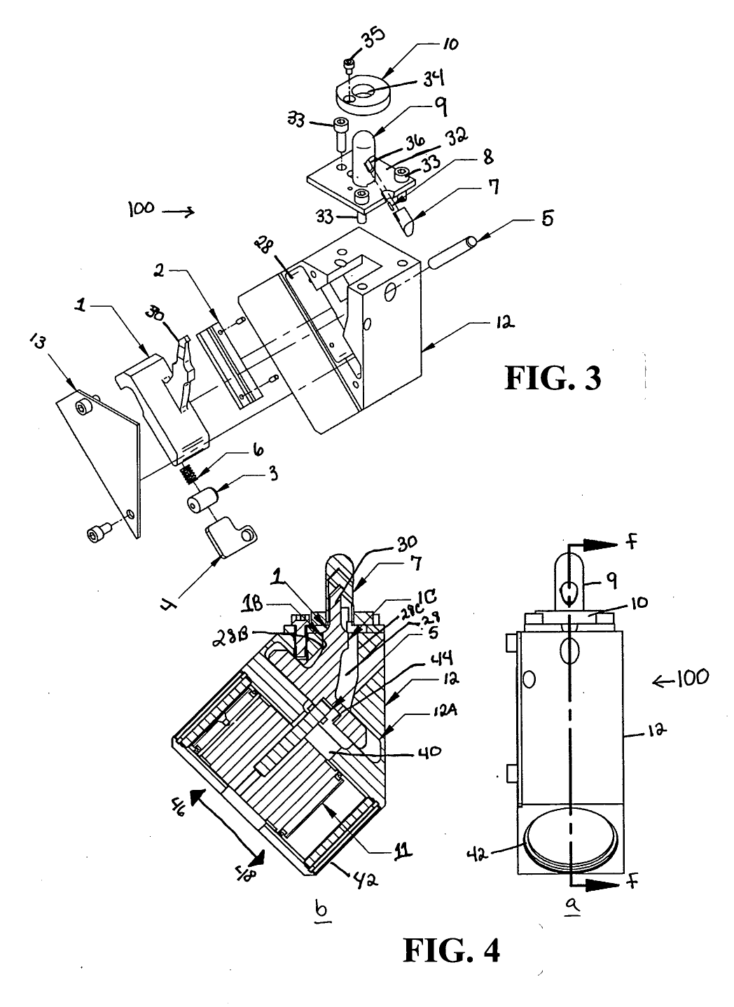

An exploded view of pin clamp assembly 100 is shown in FIG. 3. In this illustrative embodiment, clamp assembly 100 comprises a body 12 having an opening 28 formed therein to allow movement of driver 1 at an angle. Opening 28 facilitates linear movement of driver 1. In one illustrative embodiment, the angle may be measured with respect to the longitudinal axis 64 (see FIGS. 5a-c) of main pin 9 which may be about 45 degrees. It is appreciated, however, that in alternative embodiments, this angle can be varied. For example, an angle of 30 degrees may be employed. In addition, it is appreciated that the shape and form of opening 28 may be such that it facilitates or enhances movement of driver 1, to extend or retract finger 7.

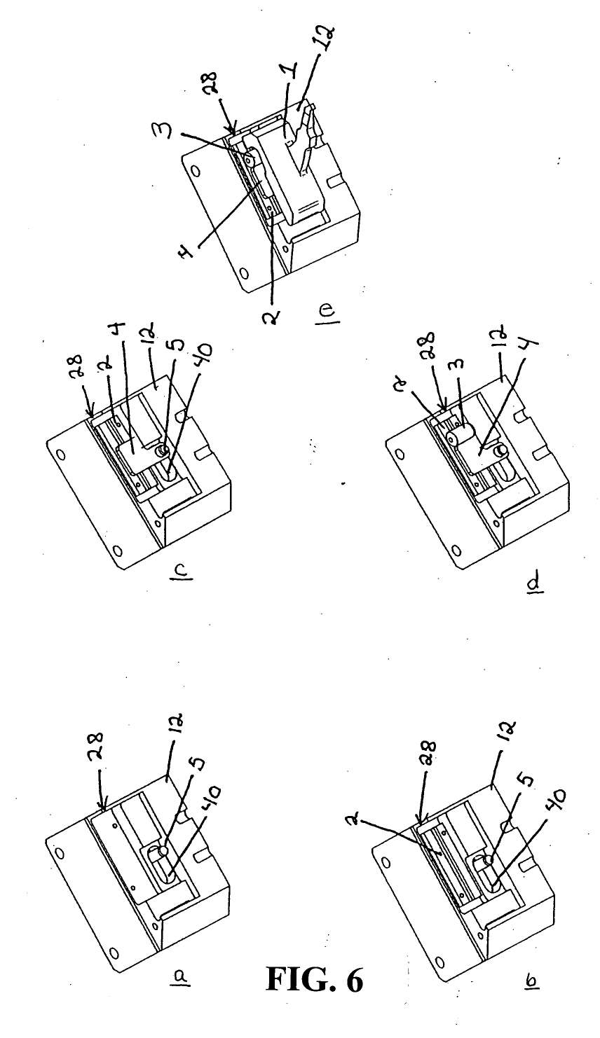

In the illustrated embodiment, driver 1 is movable between first and second positions and comprises an arm 30 configured to engage finger 7 to move the same between retracted and extended positions. In addition, a race 2 may be illustratively disposed in opening 28 along with plate 4, lock pin 3, and spring 6 illustratively located between race 2 and driver 1. (See, e.g., FIGS. 6-8.) A cover 13 is configured to selectively conceal opening 28. Also shown is drive pin 5 that illustratively extends into body 12 coupling piston 11 and driver 1. (See also FIGS. 5a-c.)

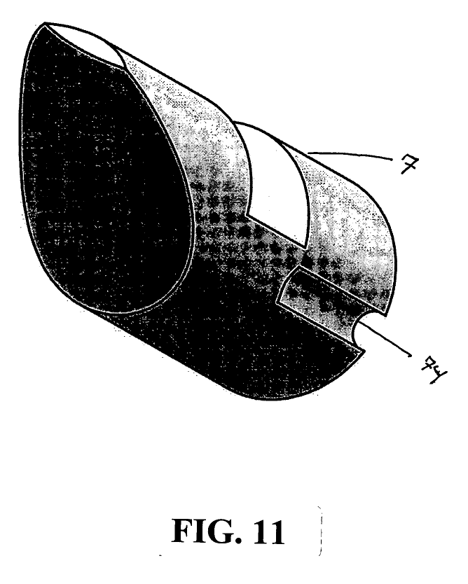

A plate 32 is illustratively configured to receive main pin 9 and is fastened to body 12 via fasteners 33. Support boss 10 has an opening 34 that receives pin 9, and is illustratively configured to support a workpiece. In the illustrative embodiment, a fastener 35 is used to attach boss 10 to plate 32. Finger 7 is received in an opening 36 in main pin 9, and is movable therein between extended and retracted positions. In the extended position (see, e.g., FIG. 2c), finger 7 is exposed to contact the workpiece in order to hold the same in a desired position. Also in an illustrative embodiment, when retracted, finger 7 does not obstruct removal of the workpiece from main pin 9. In another illustrative embodiment, finger 7 is retracted into pin 9 so as not to be exposed exterior thereof. In an illustrative embodiment, a rotation stop pin 8 is located in a conforming groove 74 in both finger 7 and the side wall of opening 36. (See, also, FIG. 11.) Stop pin 8 is configured to prevent finger 7 from rotating with respect to opening 36.

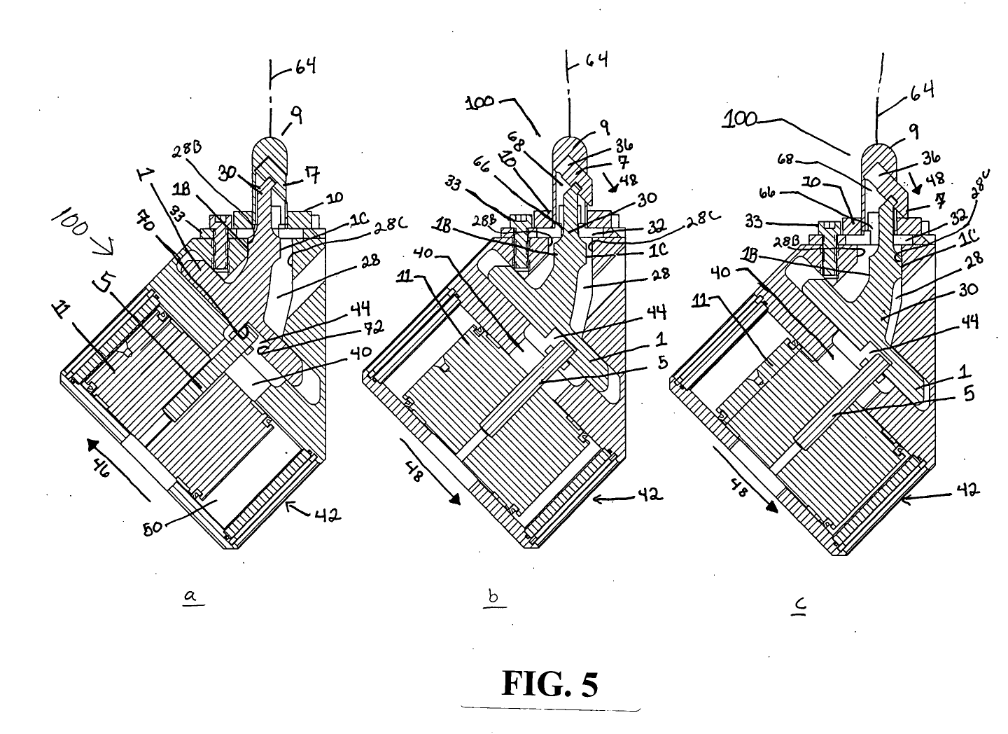

End and cross-sectional views of clamp assembly 100 are shown in FIGS. 4a and b. Regarding the view in FIG. 4b, a piston assembly 42 is shown located therein. Piston 11 of assembly 42 is coupled to drive pin 5 which is also coupled to driver 1. As previously stated, it is appreciated that in an alternative embodiment, piston assembly 42 can be replaced by another drive mechanism that can move drive pin 5, as described herein. Such an alternative drive mechanism may be an electric motor in conjunction with lead screws, gears, and/or linear motors, for example.

As shown in this illustrative embodiment, drive pin 5 extends through slot 40 and engages an opening or slot 44 illustratively located in driver 1. Accordingly, as fluid moves piston 11 in direction 46, drive pin 5 is also moved in direction 46. Conversely, when piston 11 is moved in direction 48, so too is drive pin 5 and, thus, driver 1 as well. Also shown in this view is the portion of opening 28 that receives arm 30 of driver 1. Illustratively, arm 30 comprises surfaces 1B and 1C that are configured to limit the movement of driver 1 by engaging side walls 28B and 28C, respectively, of opening 28. Side walls 28B and 28C of opening 28 illustratively serve as stops which limit the stroke of driver 1. In addition, arm 30 is configured to extend in main pin 9 and engage finger 7. It is appreciated that the clearance fit shown between arm 30 and finger 7 is illustrative. Other means of attachment known or to be contemplated by those skilled in the art may be employed in alternative embodiments. Additionally, the attachment between arm 30 and finger 7, in conjunction with opening 36, defines the direction and angle with which finger 7 travels. (See, also, FIG. 3.) It is appreciated that structures 30, 7, and 36 can be modified to change the angle and/or direction of movement of finger 7 in alternative embodiments.

A series of cross-sectional progression views showing the movement of those structures that contribute to the movement of finger 7 are shown in FIGS. 5a-c. Pin clamp assembly 100 is shown in FIG. 5a with finger 7 located in the retracted position. Fluid from port 22 is disposed in piston chamber 50 to fill the same, to move piston 11 in direction 46. Illustratively, the movement of piston 11 in direction 46 moves driver 1 also in direction 46 via drive pin 5. This movement of driver 1 causes finger 7 attached therewith to move as well. In this illustrative embodiment, surface 1B of driver 1 is shown engaged against the inner wall of opening 28. This engagement serves to limit the stroke of driver 1. Also shown in this view is how finger 7 is retracted into pin 9 which keeps finger 7 from obstructing the addition or removal of a workpiece from boss 10.

When piston 11 moves in direction 48, as shown in FIG. 5b, piston 11 moves driver 1 and finger 7 toward an extended position. In this illustrative embodiment, piston 11, driver 1, and finger 7 can all move in concurrent direction 48. Illustratively, finger 7 is configured to also move in an outward and downward direction toward support boss 10. This allows workpieces of varying thicknesses to be supported by boss 10 and held by finger 7. In the illustrated embodiment, the angle of movement of finger 7 shown is approximately 45 degrees relative to the longitudinal axis 64 of pin 9. It can be appreciated by those skilled in the art, however, that in alternative embodiments, this angle of linear movement can be varied to suit various needs and applications. For example, the angle may alternatively be about 20 degrees or about 60 degrees. Other angles may work as well. In still other alternative embodiments the finger, driver, and piston may not move in precisely concurrent directions.

Also shown in views 5a-c is how arm 30 of driver 1 extends through opening 66 of plate 32 to extend into opening 68 of pin 9 to engage finger 7. Further shown is the illustrative means of engagement between arm 30 and finger 7.

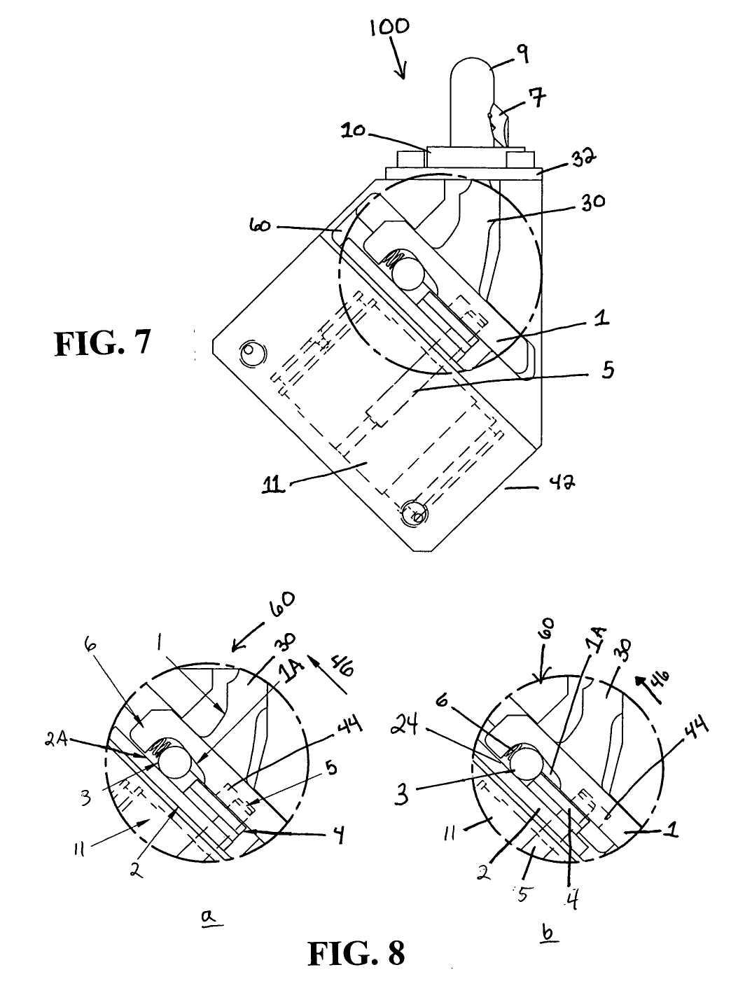

An illustrative interaction between drive pin 5 and driver 1 within slot 44 is also demonstrated in these views. When piston 11 is positioned, as shown in FIG. 5a, pin 5 engages surface 70 of slot 44 pushing driver 1 in direction 46. As piston 11 moves in direction 48, as shown in FIG. 5b, pin 5 moves along slot 44 and engages surface 72 to move driver 1 in direction 48 as well. In this illustrative embodiment it is contemplated that at some point along the stroke, pin 5 may move through slot 44 without engaging any surface and, thus, not move driver 1. The space in slot 44 accommodates an unlocking mechanism 60. (See e.g., FIGS. 7 and 8a-b.) It is appreciated, however, that in alternative embodiments, including those that may or may not include various embodiments of mechanism 60, drive pin 5 may be directly coupled to or engaged with driver 1 without any slot that allows movement of one without the other.

As piston 11 moves further in direction 48, pin 5 moves driver 1 and arm 30 to extend finger 7, as shown in FIG. 5c. In this illustrative embodiment the end of the stroke may be defined by contact between stop surface 1c of arm 30 and the inner wall of opening 28. Modifying either one or both of these structures can further limit or expand the extent of the stroke of finger 7. In alternative embodiments other structures may be added, or portions of driver 1 may be modified as determined by those skilled in the art, to redefine the end of the stroke of driver 1 to influence the finger.

A partially cut-away view of body 12, exposing opening 28 and associated structures located therein, is shown in FIGS. 6a-e. Many of these structures combine to form mechanism 60. In the illustrated embodiment, FIG. 6a shows opening 28 and slot 40, with pin 5 extending therethrough. In FIG. 6b, race 2 is shown attached to the surface of opening 28. In this illustrative embodiment race 2 longitudinally extends along a path of travel of plate 4 which is shown coupled to pin. 5 in FIG. 6c. Race 2 may also longitudinally extend along a path of travel of driver 1. Next, lock pin 3 is shown positioned adjacent both plate 4 and race 2. Driver 1 is shown illustratively located over plate 4, lock pin 3, race 2, and drive pin 5, in FIG. 6e. In this illustrated embodiment, opening 28 is shown configured to allow linear movement of driver 1 therein.

An illustrative embodiment of clamp assembly 100 comprising mechanism 60 is shown in FIGS. 7 and 8a and b. Mechanism 60 may allow pin clamp assembly 100 to hold finger 7 in the extended position even when fluid or other actuation means is cut or otherwise lost to driver 1. Illustratively, mechanism 60 can also be unlocked to allow retraction of finger 7. Detailed views of locking mechanism 60 are shown in FIGS. 8a and b. Specifically in regards to FIG. 8a, mechanism 60 is shown in the locked position. In this position, lock pin 3 is held against angled surface 1 A of driver 1 and surface 2A of race 2, by lock spring 6. In other words, lock spring 6 assists pin 3 in being wedged between driver 1 and race 2. The result of this is that driver 1 is unable to move in direction 46, illustratively the retraction direction for this embodiment of pin clamp. The result of this wedging is that driver 1, and ultimately finger 7, cannot move without lock pin 3 being forced out of its wedged position.

The unlocking component of mechanism 60 as shown in FIG. 8b. For example in this embodiment, when piston 11 or other power source moves drive pin 5 in direction 46, plate 4 which is attached to drive pin 5, moves up along race 2 to engage lock pin 3. The actuation force that is applied through plate 4 against pin 3 is enough to counteract the bias of spring 6 and dislodge pin 3 from surfaces 1A and 2A, as shown therein. This allows drive pin 5 to move driver 1 in direction 46 which ultimately retracts finger 7. It is appreciated that in one embodiment slot 44 of driver 1, which receives drive pin 5, allows plate 4 to dislodge pin 3 out of its wedging position before drive pin 5 exerts a force on driver 1 to move the same in direction 46. Consequently, drive pin 5 is free to move driver 1 and retract finger 7 once the locking mechanism 60 has been disengaged.

Another illustrative embodiment of the pin clamp assembly provides a detection mechanism that identifies when a workpiece has been correctly placed on the clamp. Illustratively a switch is mounted within the perimeter of the boss or part support to detect whether the workpiece has been correctly placed.

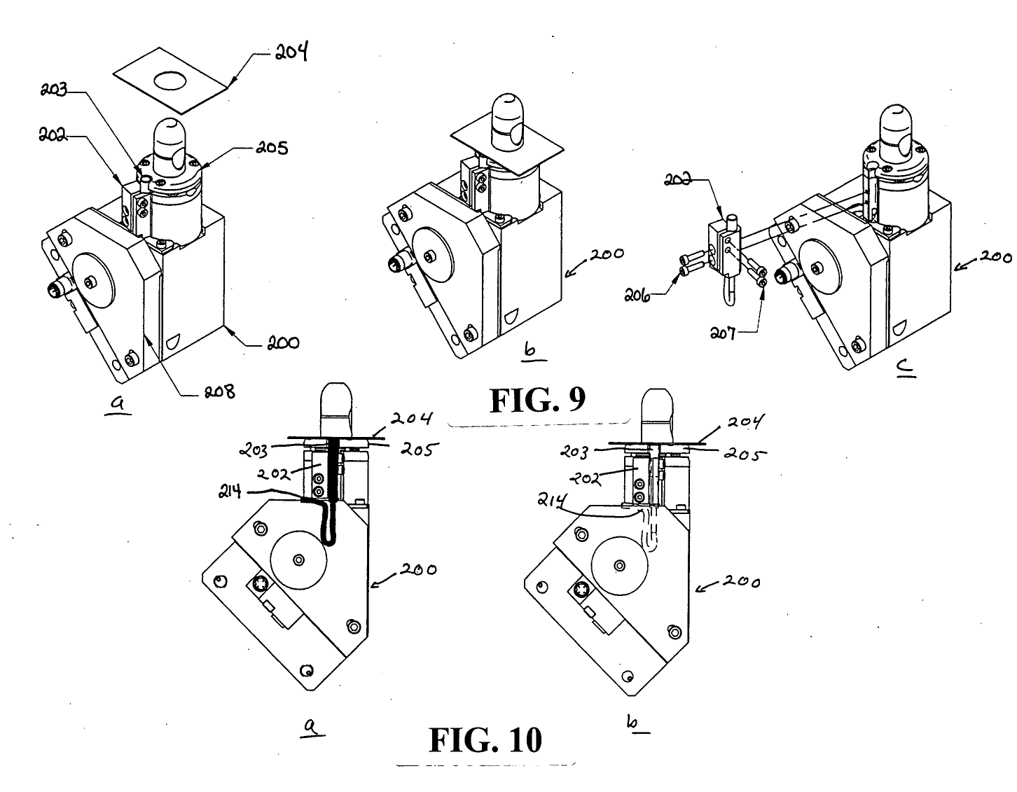

As shown in FIG. 9, a pin clamp assembly 200 comprises a panel switch 203 mounted to the side. Panel switch 203 may be any sensing solution that provides a signal when a workpiece is brought within a certain proximity (sometimes referred to as the “sensing distance”) of the switch. Panel switch 203 may also operate on various principles, including, but not limited to, induction, optics, direct contact, etc. It is appreciated that panel switch 203 may be used in conjunction with the standard positional sensing switches on a pin clamp.

In any event, when workpiece 204 is not within the proximity of the panel switch 203, it does not generate a “sense” signal. When workpiece 204 is placed on part support 205, panel switch 203 generates a “sense” signal. This indicates that the part has been placed correctly on clamp 200 and it can be used to grip workpiece 204. In an illustrative embodiment positional sensing switch 208 generates “clamp” and “unclamp” signals independently of panel switch 203. Positional sensing switch 208 may further include an adjustment mechanism that moves switch 208 relative to pin clamp assembly 200.

As illustratively shown, panel switch mounting bracket 202 is mounted to the side of clamp 200 using two fasteners 206. A proximity switch is held in panel switch mounting bracket 202 using fasteners 207. The vertical position of panel switch 203 can be adjusted by loosening the fasteners 207, moving panel switch 203 and then retightening fasteners 207. This also may enable the use of the same mounting bracket for a variety of pin sizes on the pin clamp assemblies.

Panel switch cable 214 may be routed through the internal area of clamp 200 as shown in FIGS. 10a and b. Illustratively nesting panel switch 203 inside the perimeter of part support 205 provides a sensor that is as close as possible to the hole that is being clamped. This also takes up as little space as possible around the part support, which may maximize clearances for weld heads or other machine parts. Note that panel switch 203 may completely or partially extend from the perimeter of part support 205 in alternate embodiments.

Finger 7 of clamp assembly 100 is shown in FIG. 11. This view shows channel 74 configured to receive rotation stop pin 8, as previously discussed with respect to FIG. 3.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A pin clamp assembly comprising:
a driver;
a body having a cavity that receives at least a portion of the driver and which comprises first and second stops;
an actuator assembly that comprises a drive rod that moves the driver linearly;
a locating pin that has a longitudinal extent and receives at least a portion of the driver; and
at least one finger, at least a portion of which is locatable in the locating pin and at least a portion is selectively extendable therefrom;
wherein the driver is linearly movable between the stops to move the finger between extended and retracted positions;
wherein at least a portion of the actuator assembly and the driver move substantially parallel to each other to move the finger; and
wherein the portion of the actuator assembly and the driver moves non-parallel to the longitudinal extent of the locating pin.

2. The pin clamp assembly of claim 1, wherein the driver has first and second stop surfaces located thereon.

3. The pin clamp assembly of claim 2, wherein the at least portion of the actuator assembly and the driver move along a linear path transversely located relative to the longitudinal extent of the locating pin.

4. The pin clamp assembly of claim 3, wherein the at least portion of the actuator assembly and the driver move linearly at an approximate 45 degree angle to the longitudinal extent of the locating pin.

5. The pin clamp assembly of claim 4, wherein the finger moves substantially parallel to the at least portion of the actuator assembly.

6. The pin clamp assembly of claim 2, wherein the first stop surface is located adjacent the first stop when the finger is located in the retracted position and the second stop surface is located adjacent the second stop when the finger is located in the extended position.

7. The pin clamp assembly of claim 6, wherein the finger moves linearly and substantially parallel to movement of the driver and the at least portion of the actuator assembly.

8. The pin clamp assembly of claim 5, wherein the actuator assembly comprises a piston that moves substantially parallel to the driver.

9. The pin clamp assembly of claim 1, wherein the finger moves linearly and substantially parallel to movement of the driver and the at least portion of the actuator assembly.

10. The pin clamp assembly of claim 8, wherein the piston, actuator assembly and finger all move substantially parallel each other to extend and retract the finger to and from the locating pin.

11. The pin clamp assembly of claim 1, further comprising a locking assembly that holds the driver preventing it from moving until forced to do so by the actuator assembly.

12. The pin clamp assembly of claim 1, further comprising a locking assembly that comprises a wedge that engages the driver holding it in place until that actuator assembly dislodges the wedge allowing the driver to move.

13. The pin clamp assembly of claim 1, further comprising a sensor that detects the location of the driver.

14. The pin clamp assembly of claim 1, further comprising a sensor that detects when a workpiece engages the pin clamp assembly.

15. The pin clamp assembly of claim 1, further comprising a sensor assembly that detects the location of the driver and when a workpiece engages the pin clamp assembly.

16. A method of holding a panel having a grippable edging or hole disposed therethrough, the method comprising the steps of:
providing a locating pin that defines a longitudinal axis, a surface, and a piston coupled to a driver which is coupled to a finger located in the locating pin;
locating the locating pin through the hole or adjacent the edging;
moving the piston linearly and transversely to the longitudinal axis of the locating pin;
moving a driver via movement of the piston linearly and substantially parallel to the piston;
moving the finger linearly via movement of the driver at least partially outwardly from the locating pin; and
holding the panel against the surface with the finger.

17. The method of holding the panel of claim 16, the method further comprising the step of moving the finger substantially parallel to the piston.

18. The method of holding the panel of claim 16, the method further comprising the steps of providing opposed stops with a portion of the driver located therebetween, and limiting movement of the finger based on the distance between the stops.

19. The method of holding the panel of claim 16, the method further comprising the step of holding the finger at a location under a loss of power on the piston.

20. A pin clamp assembly comprising:
a locating pin having a longitudinal axis extending therethrough, a piston, a driver, and a finger; the piston is linearly movable transversely to the longitudinal axis of the locating pin; the driver is spaced apart from the piston and movable substantially parallel to the movement of the piston; and the finger is movable substantially parallel to the movement of the driver, and at least a portion of the finger is movable into and out of the locating pin.

21. The pin clamp assembly of claim 20, wherein the piston, driver, and finger move linearly at an approximate 45 degree angle to the longitudinal axis.
